(19) United States
(12) Patent Application Publication
(10) Pub. No.: US 2012/0197630 A1
(43) Pub. Date: Aug. 2, 2012

(54) METHODS AND SYSTEMS TO SUMMARIZE A SOURCE TEXT AS A FUNCTION OF CONTEXTUAL INFORMATION

(76) Inventors: Kenton M. LYONS, Santa Clara, CA (US); Barbara ROSARIO, Berkely, CA (US); Trevor PERING, San Francisco, CA (US); Roy WANT, Los Altos, CA (US)

(21) Appl. No.: 13/015,928

(22) Filed: Jan. 28, 2011

(51) Int. Cl. G06F 17/27

(52) U.S. Cl. 704/9

(57) ABSTRACT

Methods and systems to summarize a source text as a function of contextual information, including to fit a summary within a context-based allotted time. The context-based allotted time may be apportioned amongst multiple portions of the source text, such as by relevance. The context-based allotted time and/or relevance may be user-specified and/or determined, such as by look-up, rule, computation, inference, and/or machine learning. During summary presentation, one or more portions of the source text may be re-summarized, such as to adjust a level of detail. A presentation rate may be user-controllable. Where new and/or changed contextual information affects an available time to review a remaining portion of the summary, the summary presentation may be automatically adjusted, and/or one or more portions of the source text may be re-summarized based on a revised context-based allotted time.

### BACKGROUND

Individuals may have periods of time in which to read or listen to material. Durations of the periods of time may vary by individual, and may vary for a given individual, depending on context.

Audio systems have been developed to construct a playlist of pre-recorded songs to fill an allotted time. Audio systems have been also been developed to slightly adjust audio playback speed to achieve minor time variations in the playback.

For written material, a text summarizer may generate a condensed version or summary of one or more source texts. A text summarizer may extract relevant information from the source text, such as key terms, phrases, sentences, and/or paragraphs, or may paraphrase or abstract portions of the source text, such as with a natural language processing (NLP) technique.

A text summarizer may condense a source text based on a compression rate or ratio, which may represent a degree to which a feature of the source text (e.g., word count), is to be reduced.

The compression rate alone, however, does not determine a reading or listing time of a textual summary.

### BRIEF DESCRIPTION OF THE DRAWINGS/FIGURES

FIG. 1 is a flowchart of a method of summarizing a source text based on contextual information, including a context-based allotted time.

FIG. 2 is a flowchart of a method of apportioning the context-based allotted time amongst multiple portions of a source text, such as to provide a greater level of detail to one or more portions of a summary.

FIG. 3 is a flowchart of a method of re-summarizing one or more portions of a source text as a function of a revised context-based allotted time.

FIG. 4 is a flowchart of a method 400 of selecting adjusting a presentation rate of a text summary.

FIG. 5 is a block diagram of a system to summarize a source text based on contextual information, including a context-based allotted time.

FIG. 6 is a block diagram of the context-based text compression system configured to apportion a context-based allotted time amongst multiple portions of one or more source texts.

FIG. 7 is a block diagram of a computer system, configured to summarize a source text based on contextual information, including a context-based allotted time.

In the drawings, the leftmost digit(s) of a reference number identifies the drawing in which the reference number first appears.

### DETAILED DESCRIPTION

Disclosed herein are methods and systems to summarize a source text based on contextual information, including a context-based allotted time.

The term, “contextual information,” as used herein, refers to information that may vary, such as between individuals, by location, situation, over time, and/or with respect to one or more other variables. Contextual information may include, for example and without limitation, user-specific information and/or non-user-specific information. Contextual information may include user-input such as, without limitation, a user-selection, a user-response, and/or user-feedback. Contextual information may be received from one or more of a variety of information sources, which may include a user device and/or other systems, such as described below.

The term, “determined from contextual information,” as used herein, may include look-up, rule, computation, inference, machine learning, and combinations thereof. An inference may be based on one or more other inferences. A determination based on contextual-information may be presented to a user for verification and/or acceptance.

Contextual information may with fall within one or more of a variety of categories, which may include:
user-context information;
event information,
location information,
travel information;
environmental information, and
historical information.

User-context information may include, for example, information indicative of a current user activity and/or status, such as driving, sitting, talking, emotional status, and/or health. User-context information may include social network information. User-context information may include user proximity information, which may include, for example, identifications of people in proximity of the user and/or other information associated with a user-vicinity, which may include information obtained and/or derived from background audio received by a user device, such as an ambient noise level.

Event information may relate to a place and/or time, and may include public and/or private events, such as meetings, appointments. Event information may include start and/or end times, locations, departure and/or arrival times and/or locations. Event information may include and/or be obtained from calendar and/or schedule information, which may be user-specific and/or non-user specific, such as a calendar of events at a venue.

Location information may include, without limitation, user and/or event location information.

Travel information may include, without limitation, user-movement information, such as position, direction, speed, route, mode of transit information.

Environmental information may include information that may be relevant to other contextual information, such as weather, traffic, and/or other news information.

Historical information may include user-specific historical information and/or non-user-specific historical information. Historical information may include computer-based activity, which may include, without limitation:
application usage;
searches;
electronic communications;
address, phone book or other contact lists;
calendars and schedules;
web site and/or on-line account access activity, such as social network sites, leisure sites, professionally-related sites, travel planning sites, merchant sites; and/or
user-responses to computer-based questions.

The listing above is provided for illustrative purposes. Methods and systems disclosed herein are not limited to example types of contextual information provided herein.

Contextual information may be obtained and/or received from one or more of a variety of information sources.

An information source may include a computer-accessible information source and/or a system or device configured to communicate information to a computer system, such as a monitoring, sensing, and/or reporting system.

A computer-accessible information source may include a local or remote data storage device, and/or a network-accessible server, which may include an internet-accessible server.

An information source may include a wireless, and/or wired or cable-based system.

An information source may include may include a broadcast system and/or an account-based, query-based, and/or request-based system.

An information source may include a personal or user-based information source, which may include, without limitation, a computer system, a communication system, a portable and/or hand-held device, a vehicle mounted system, a position location system, and/or a monitoring and/or sensing system, such as a pedometer.

An information source may include an access-restricted information source. For example, where a summary is to be presented in a public environment, such as a customer waiting area, the context-based allotted time may be based on an anticipated waiting time, which may be based, at least in part, on proprietary and/or confidential information.

The listing above is provided for illustrative purposes. Methods and systems disclosed herein are not limited to example types of information sources listed herein.

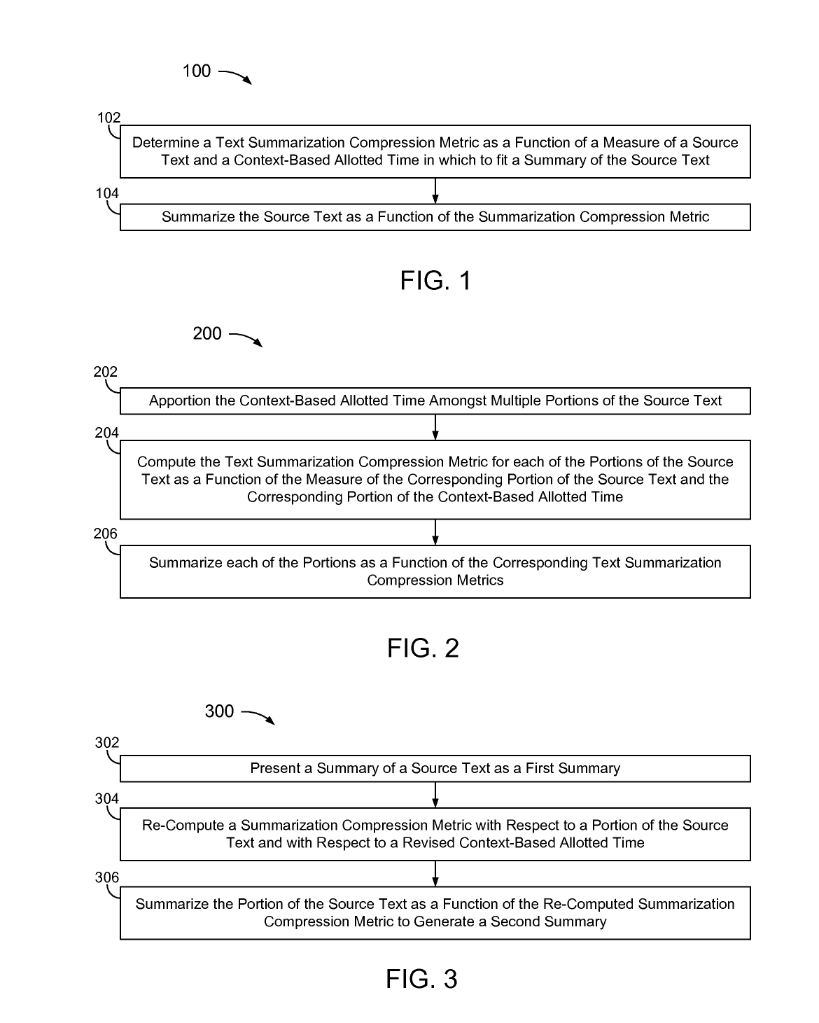

FIG. 1 is a flowchart of a method 100 of summarizing a source text based on contextual information, including a context-based allotted time.

At 102, a text summarization compression metric is determined as a function of a measure of a source text and a context-based allotted time in which to fit a summary of the source text.

The source text may include computer readable text, which may be maintained in and/or retrievable from a computer-accessible information source and/or other media such as, for example speech, which may be transcribed into text by a speech recognizer, and/or images, which may be translated into text by an optical character recognition system.

The context-based allotted time may represent a context-based period of time during which a summary may be read or listened to.

The context-based allotted time may be based on an individual or user, and/or an environment or situation, such as a professional office waiting room, telephone on-hold period, a consumer check-out line, public transportation, and/or a public transportation waiting area.

The context-based allotted time may be defined, at least in part, by contextual information, and may be user-specified and/or determined from contextual information.

Examples of determining context-based allotted time are provided below. Methods and systems disclosed herein are not, however, limited to the examples.

The context-based allotted time may correspond to a period of time preceding an event, such as a meeting or other appointment. An event, or event start time, may be user-specified or may be determined from contextual information. For example, an event, or event start time may be determined from a computer-based user calendar, schedule, or appointment. An event may be determined from user electronic communications, which may include, without limitation, electronic mail, or e-mail, instant messages, chats, blogs, social network site postings, and/or tweets. An event may be determined from a combination of types of contextual information.

The context-based allotted time may be determined based at least in part on user-context information. User-context information may include present user activity, status, and/or proximity information, such as described above.

User-context information may be used to initiate method 100. For example, where a system determines that a user is sitting or driving, the system may initiate method 100. The system may take into account user proximity information in determining whether to initiate system 100.

The context-based allotted time may be based, at least in part, on a travel or transit time, which may be user-specified or determined from contextual information. A transit time may be determined from, for example, departure and destination locations, route, and/or mode of travel, which may be user-specified and/or determined from contextual information.

A departure location may be determined from user-location information and/or other contextual information.

A destination location may be determined from, for example, user computer-based activity, such as electronic communications and/or computer-based searches or inquiries. For example, a user may conduct a computer-based on-line search for a store locator, and may access a page that displays store hours and/or directions. User motion may subsequently be detected, such as from position location information of a user mobile device, which may include global positioning satellite (GPS) technology. A combination of the computer-based search and the user-motion information, alone and/or in combination with other contextual information, may be used to determine that the user is traveling to the store.

Mode of travel may include, for example, an automobile, a mode of public transportation, and/or walking, and may be determined from one or more of prior user history, departure and/or destination location, route, distance, day of week, and/or other factors.

A travel route may be computed or obtained from an information source, such as an on-line route-planning system. A transit time may be determined as a function of the route and mode of travel. The transit time may be determined and/or adjusted based on contextual information, such as traffic information, weather information, special events in a vicinity of the travel route, type of day, such as weekday, weekend, and/or holiday, and/or prior user transit behavior or patterns, such as speed, route, and mode of travel.

Alternatively, the travel time may be obtained from on the on-line route-planning system, and may be adjusted based on contextual information, such as described above.

Determining of the compression metric is now described.

A form or format of the compression metric may depend upon or be specified by a text summarization technique. The compression metric may include or correspond to, for example, a compression rate, compression ratio, and/or other compression metric. The compression metric may be a unit-less value.

Determination of the compression metric may include determining an amount or degree to which a measure of the source text is to be reduced or compressed to obtain a summary that corresponds to the context-based allotted time. The measure may relate to, for example, a number of words, sentences, paragraphs, spaces, and/or punctuation marks, and/or a volume or amount of data, such as a file size.

The compression metric may be determined based the measure of the source text and the measure to be attained in the summary.

For example, where the measure includes word count, and where the context-based allotted time is 3 minutes, the compression metric may be determined based on a difference between the word count of the source text, and the number of words that may be read or listened to in 3 minutes. Similarly, where the measure includes file size, the compression metric may be determined based on a difference between a file size of the source text and a file size that corresponds to a 3 minute summary.

The measure of the summary may be determined by computation and/or from a look-up a table that includes a listing of time-allotments and corresponding measures.

The measure of the source text may be determined by examination of the source text, and/or from meta-data or tags associated with the source text.

The compression metric may be determined based on a difference between the measure of the source text and the measure to be obtained by the summary, and may be expressed as a ratio, percent, and/or other factor.

Determination of the compression metric is not, however, limited to the examples above.

At 104, the source text is summarized as a function of the compression metric to generate a summary of the source text. The summarization may include a natural language process (NLP) technique, and may be performed with a machine-implemented text summarizer, such as a computer-implemented text summarizer.

Where contextual information changes subsequent to determination of a factor, such as the context-based allotted time, the factor may be re-determined based on revised contextual information, such as described below with reference to FIG. 3.

FIG. 2 is a flowchart of a method 200 of apportioning the context-based allotted time amongst multiple portions of a source text, such as to adjust a level of detail of one or more portions of a summary.

At 202, a context-based allotted time is apportioned amongst multiple portions of a source text.

The context-based allotted time may be received and/or determined, such as described above with respect to 102 in FIG. 1.

The source text may correspond to a text document or file, and the multiple portions of the source text may correspond to portions of the text document or file.

The source text may correspond to a multiple text documents or files, and the multiple portions of the source text, or a subset thereof, may each correspond to a one of the text documents or files.

The multiple portions of the source text may be distinguishable from one another based one or more of a variety of features, such as source, subject matter, content, document type, and/or file type. For example, the multiple portions of the source text may correspond to news stories, which may be distinguishable by source and/or subject matter. As another example, the multiple portions of the source text may correspond to electronic communications, such as e-mail, which may be distinguishable by sender, recipient, subject line, and/or subject matter.

The context-based allotted time may be apportioned unequally amongst the portions. For example, the context-based allotted time may be apportioned to provide more time in the summary, and thus greater detail, for one or more portions of the source text relative to one or more other portions of the source text.

The context-based allotted time may be apportioned based on contextual information, such as relevance.

Relevance may be applied as a relative ranking, ordering, and/or prioritization of the multiple portions of the source text. Alternatively, or additionally, a measure or indication of relevance may be associated with each portion of the source text.

Relevance may be user-specified. For example, a user may tag or rank the multiple portions of the source text through a graphical user interface, and/or may indicate preferences a priori, which may be based on subject matter, information source, and/or other factor(s). Additionally, the apportionment of the context-based allotted time may be user-initiated. For example, during presentation of a previously generated summary, a user may opt for greater detail with respect to one or more portions of the summary. In such a situation, apportionment may be initiated in conjunction with a revised context-based allotted time, such as described below with respect to FIG. 3

Alternatively, or additionally, relevance may be determined from contextual information. For example, the context-based allotted time may correspond to a time preceding a user-appointment. A determination may be made that one or more portions of the source text are more relevant to the appointment than one or more other portions of the source text. For example, the source text may include e-mail messages, a subset of which may be determined to be more relevant to the appointment than other messages. Such a determination may be based on message sender, recipient, subject matter line, message body, attachments, and/or prior user actions taken in response to similar messages. The subset of the more relevant messages may be allotted more time, and thus greater detail, than other messages, so as to provide a greater level of detail in corresponding portions of the summary.

At 204, a text summarization compression metric is computed for each portion of the source text as a function of a measure of the corresponding portion of the source text and the corresponding allotted time, such as described above with respect to 102 in FIG. 1.

At 206, the multiple portions of the source text are summarized as a function of the corresponding compression metrics to generate a summary.

FIG. 3 is a flowchart of a method 300 of re-summarizing one or more portions of a source text as a function of a revised context-based allotted time.

At 302, a summary of a source text is presented as a first summary.

The summary may be generated as a function of a context-based allotted time and a compression metric, such as described above with respect to one or more of methods 100 and 200.

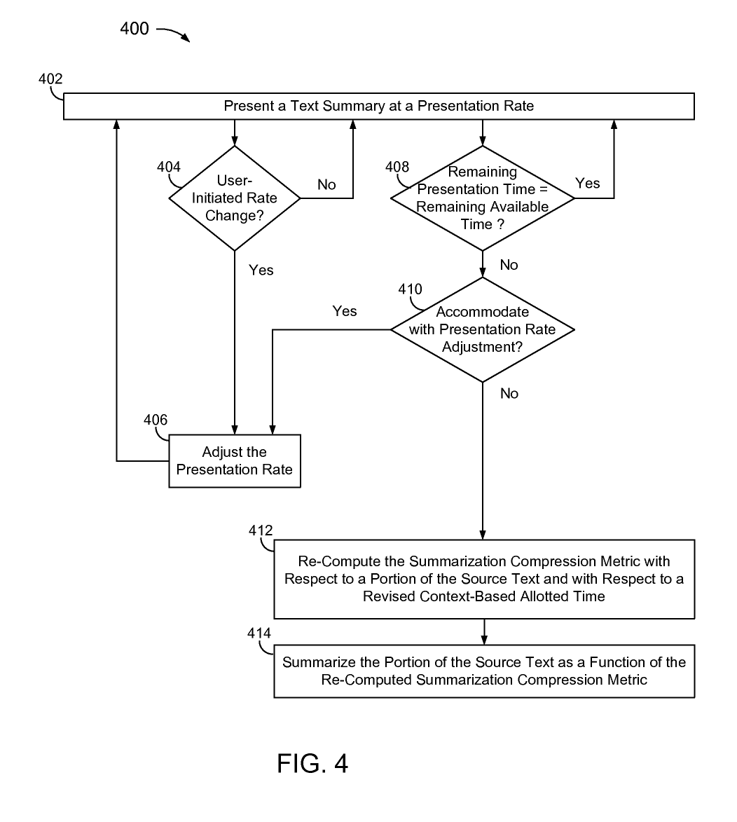

The first summary may be presented textually through a display and/or verbally through a speech synthesizer and speakers. The first summary may be presented at a presentation rate, which may be adjustable, such as described below with respect to FIG. 4.

At 304, during the presenting of the first summary, the compression metric is re-computed with respect to at least a portion of the textual content and with respect to a revised context-based allotted time.

The revised context-based allotted time may be provided by a user and/or may be computed from contextual information, such as described above with respect to 102 in FIG. 1.

The revised context-based allotted time may be apportioned amongst multiple portions of one or more source texts, such as described above with respect to method 200.

Re-computing of the compression metric may be initiated in response to user input, such as to accommodate a change in available time to review a summary, and/or to specify a greater or lesser degree of detail with respect to one or more portions of the first summary, such as described above with respect to method 200.

Re-computing of the compression metric may be initiated based on new and/or changed contextual information. For example, the compression metric may be re-computed to incorporate new source text, which may be determined to be relevant based upon contextual information. As another example, the compression metric may be re-computed based on new and/or changed contextual information that may increase or decrease a user's available time to read or listen to a remaining or un-presented portion of the first summary. Such information may relate to a transit time, and may include one or more of user location information, user movement information, such as speed, mode of transit, traffic information, weather information, change in presentation rate, and/or other information.

The revised context-based allotted time may be repeatedly re-computed, periodically and/or based on a schedule and/or one or more events, triggers, and/or rules. Such events, triggers, and/or rules may be selected or configured to detect a change in contextual information that may impact may impact an available time of the user. The compression metric may be recomputed when the revised context-based allotted time differs from a time needed to present a remaining or un-presented portion of the first summary.

The compression metric may be re-computed with respect to a remaining, or un-presented portion of the first summary, and/or with respect to one or more user-specified portions of one or more source texts, and may include apportioning the revised context-based allotted time as described above with respect to method 200.

At 306, the portion of the source text is summarized as a function of the re-computed compression metric to generate a second summary. The second summary may be presented in place of the first summary.

Where the revised context-based allotted time is apportioned amongst multiple portions of the source text, the summarizing at 306 may include summarizing each of the multiple portions of the source text, each as a function of a corresponding re-computed compression metric and corresponding portion of the revised context-based allotted time.

FIG. 4 is a flowchart of a method 400 of selectively adjusting a presentation rate of a text summary.

At 402, a text summary is presented at a first presentation rate.

The text summary may be generated as described in one or more examples herein, and may be presented textually through a display and/or verbally through a speech synthesizer and speakers.

Where the text summary is presented verbally, the presentation rate may relate to a play-back speed. Where the text summary is presented textually, the textual presentation may include a vertically and/or horizontally scrollable format, and/or a multi-page format and a presentation rate may relate to a scrolling rate and/or page turning rate.

The first presentation rate may include a default presentation rate and/or context-based presentation rate, which may be user-specified and/or determined from contextual information.

The first presentation rate may be adjustable based on contextual information, which may include user-input, such as described below with reference to 404 and 406.

Alternatively, or additionally, the first presentation rate may be machine or computer-adjustable based on other contextual information, such as described below with reference to 408 through 416, and 106.

At 404, when a user initiates a presentation rate change, the presentation rate is adjusted at 406. Processing then returns to 402, where the presentation of the text summary continues at an adjusted presentation rate.

At 408, a determination may be made that the time needed to present a remaining portion of the summary, at a current presentation rate, differs from an available time. Such a situation may arise due to new and/or changed contextual information. For example, where a context-based allotted time corresponds to a user-transit time, a change in speed, route, mode of transit, traffic, weather, and/or other factor may increase or decrease the user's available time to read or listen to the remaining portion of the summary. The determination at 408 may be based on a threshold or a threshold range.

At 410, a decision may be made to adjust the presentation rate at 406, such as described above.

Alternatively, a decision may be made at 410 to re-compute the summarization compression metric at 412 with respect to a portion of the source text and a revised context-based allotted time, such as described above with respect to 304 in FIG. 3.

At 414, the portion of the source text is summarized as a function of the re-computed text summarization compression metric to generate a revised summary, such as described above with respect to 306 in FIG. 3.

Processing then returns to 402, where the revised summary is presented at a presentation rate, such as described above.

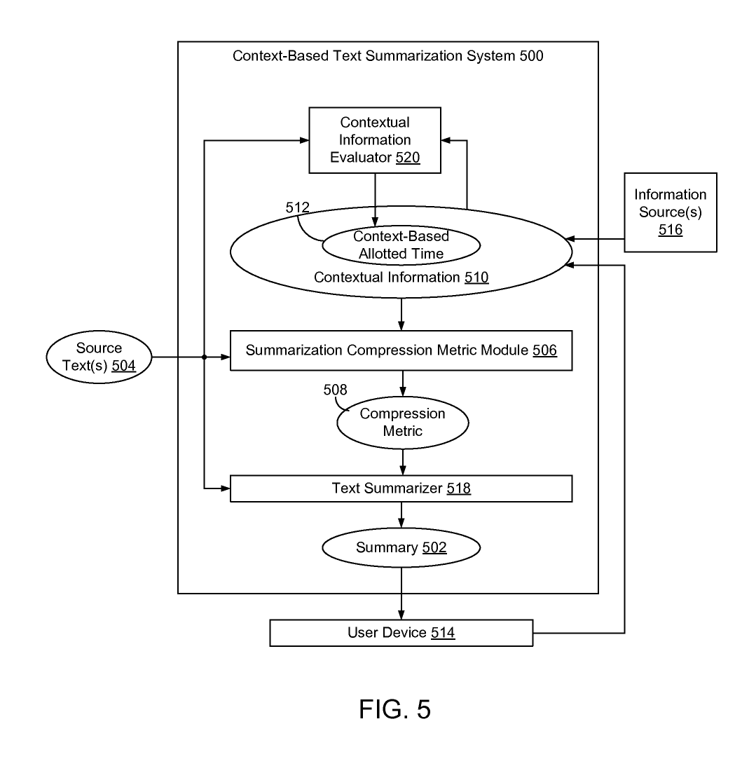

FIG. 5 is a block diagram of a system 500 to generate a summary 502 from a source text 504 based on contextual information, including a context-based allotted time.

System 500 includes a summarization compression metric module 506 to compute a compression metric 508 as a function of a measure of source text 504 and contextual information 510, such as described in one or more examples herein.

Contextual information 510 may be received from one or more information sources, which may include one or more user devices 514 and/or one or more other information sources 516, such as described in one or more examples herein.

User device 514 may include a display to present context based summary 502 textually, and or a speech synthesizer and speaker to present context based summary 502 verbally. User device 514 may further include, for example and without limitation, a hand-held user device, which may include one or more of a wireless communication system and a position location system, such as a global positioning system (GPS).

System 500 may include a communication system to receive contextual information 510, or a portion thereof, from one or more information sources 516 and/or from user device 514.

Compression metric module 506 may include a computer-accessible storage system to store contextual information 510, or a portion thereof.

Compression metric module 506 may be configured to compute compression metric 508 as a function of a context-based allotted time 512, which may be user specified and/or determined from one or more portions of contextual information 510, such as described in one or more examples herein.

System 500 may include a contextual information evaluator 520 to evaluate contextual information 510. Contextual information evaluator 520 may include one or more of a look-up table, a rule, hardware and/or software based computation logic, an inference engine, and/or a machine learning system. Contextual information evaluator 520 may be configured to determine one or more of context-based allotted time 512, a revised context-based allotted time, a time apportionment, and/or relevance, such as described in one or more examples herein.

System 500 may include a text summarizer 518 to summarize source text 504 as a function of compression metric 508 to generate summary 502, such as described in one or more examples herein. Text summarizer 518 may include a natural language processor (NLP).

Compression metric module 510 and text summarizer 516, or portions thereof, may be implemented on a shared platform, such as user device 514 or another platform.

Alternatively, compression metric calculator 510 and text summarizer 516, or portions thereof, may be implemented across multiple platforms. For example, compression metric calculator 510 may be implemented within user device 514, and text summarizer 516 may be implemented within a system external of user device 514.

System 500 and/or user device 514 may be configured to adjust a presentation rate of summary 502, such as described in one or more examples herein.

System 500 may be configured to re-compute compression metric 508 during presentation of summary 502, such as described in one or more examples herein.

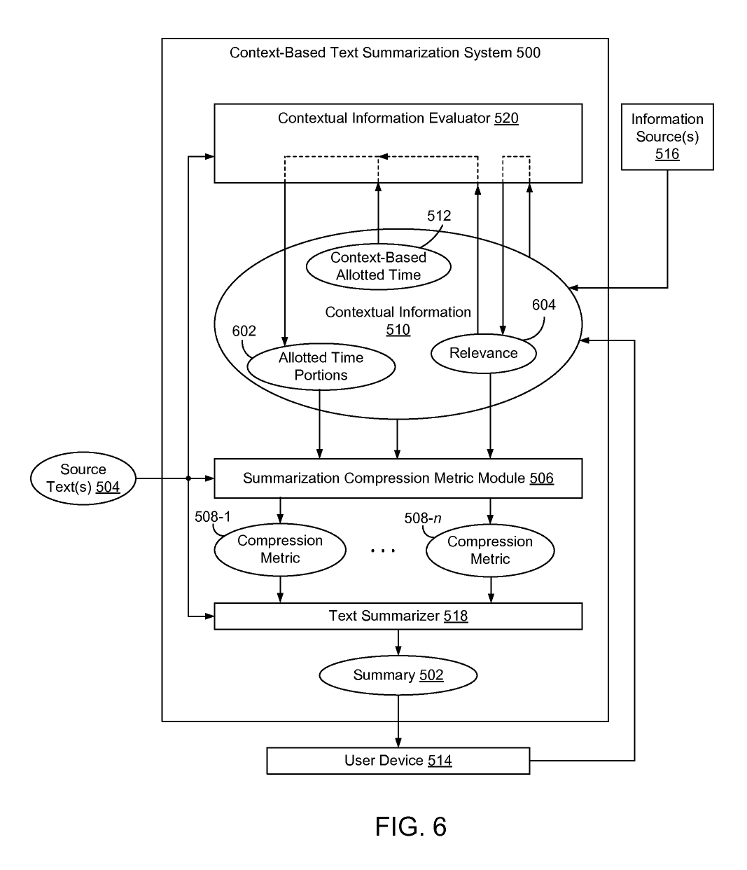

FIG. 6 is a block diagram of system 500, configured to apportion context-based allotted time 512 amongst multiple portions of one or more source texts, such as described in one or more examples herein.

In FIG. 6, contextual information evaluator 520 is configured to apportion context-based allotted time 512 amongst multiple portions 602 of source text 504, and/or multiple source texts.

Contextual information evaluator 520 may be configured to apportion context-based allotted time 512 based on an indication of relevance 604. Contextual information evaluator 520 may be configured to determine indication of relevance 604 from contextual information 510, such as described in one or more examples herein.

Compression metric module 506 may be configured to compute a plurality of compression metrics 508-1 through 508-n, for corresponding allotted time portions 602, such as described in one or more examples herein.

One or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, and/or a combination of integrated circuit packages. The terms software, code, and instructions, as used herein, refers to a computer program product including a computer readable medium having computer program logic stored therein to cause a computer system to perform one or more functions in response thereto.

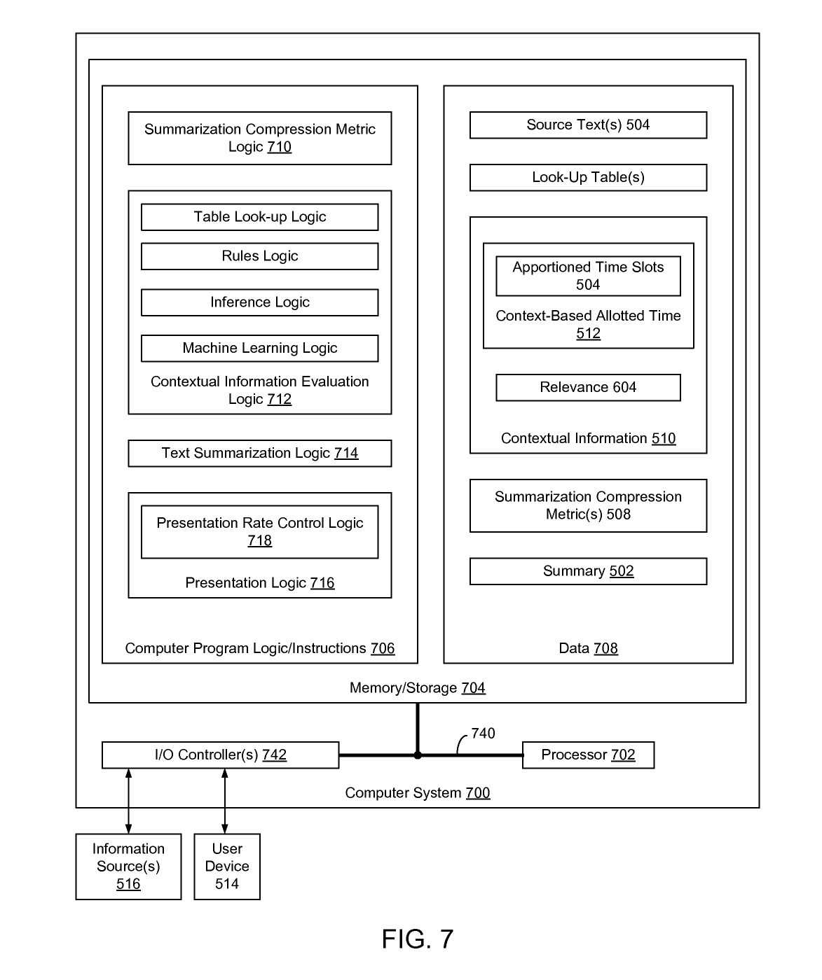

FIG. 7 is a block diagram of a computer system 700, configured to summarize a source text based on contextual information, including a context-based allotted time.

Computer system 700 includes one or more computer instruction processing units, illustrated here as a processor 702, to execute computer program product logic (hereinafter, “logic”).

Computer system 700 includes one or more of memory, cache, registers, and storage (hereinafter, “memory”) 704, including a computer readable medium having computer program product logic 706 stored thereon, to cause processor 702 to perform one or more functions in response thereto.

Memory 704 may includes data 708 to be used by processor 702 in executing instructions 706, and/or generated by processor 702 during execution of instructions 706.

Logic 706 includes summarization compression metric logic 710 to cause processor 702 to compute context-based compression metric 508 as a function of a measure of source text 504 and contextual information 510, such as described in one or more examples herein.

Summarization compression metric logic 710 may include logic to cause processor 702 to compute context-based compression metric 508 as a function of context-based allotted time 512, such as described in one or more examples herein.

Logic 706 may include contextual information evaluation logic 712 to cause processor 702 to evaluate contextual information 510. Contextual information evaluator logic 712 may include one or more of look-up table logic, rules based logic, computation logic, inference logic, and/or machine learning logic. Contextual information evaluator logic 712 may include logic to cause processor 702 to determine one or more of context-based allotted time 512, a revised context-based allotted time, apportioned time slots 504, and/or relevance 604, such as described in one or more examples herein.

Logic 706 may include text summarizer logic 714 to cause processor 702 to summarize source text 504 as a function of compression metric 508, to generate summary 502, such as described in one or more examples herein.

Text summarizer logic 712 may include natural language processor (NLP) logic to cause processor 702 to summarize source text 504 in accordance with one or more NLP techniques.

Summarization compression metric logic 710 and text summarization logic 714, or portions thereof, may be implemented on a shared platform, as illustrated in FIG. 7, and may be implanted on a platform with user device 514, or another platform.

Alternatively, summarization compression metric logic 710 and text summarization logic 714, or portions thereof, may be implemented across multiple platforms. For example, summarization compression metric logic 710 may be implemented within user device 514, and text summarization logic 714 may be implemented on another platform.

Logic 706 may include presentation logic 716, which may include one or more of text presentation logic and speech synthesis logic, to cause processor 702 to present summary 502 to a display and/or a speaker of user device 514.

Presentation logic 716 may include presentation rate control logic 718, to control a presentation rate of summary 502, such as described in one or more examples herein.

Computer system 700 may include a communications infrastructure 740 to communicate amongst systems and devices of computer system 700.

Computer system 700 may include one or more input/output (I/O) controllers 742 to interface with one or more other systems and/or platforms, such as information sources 516 and/or user device 514. I/O controller 742 may include, for example a wired and/or wireless network interface controller (NIC).

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the example embodiments disclosed herein.

What is claimed is:

1. A computer-implemented method, comprising:
determining a text summarization compression metric as a function of a measure of a source text and a context-based allotted time in which to fit a summary of the source text; and
summarizing the source text as a function of the compression metric.

2. The method of claim 1, further including:
determining the context-based allotted time from user-context information;
wherein the user-context information includes one or more of schedule information, computer activity information, location information, motion information, activity information, status information, proximity information, and electronic messages.

3. The method of claim 1, wherein the determining of the compression metric includes:
apportioning the context-based allotted time amongst multiple portions of the source text based on a relevance of the multiple portions of the source text; and
determining the compression metric for each of the portions of the source text as a function of the measure of the corresponding portion of the source text and the corresponding portion of the context-based allotted time;
wherein the summarizing includes summarizing each of the portions of the source text as a function of the corresponding compression metric.

4. The method of claim 1, further including:
determining a revised context-based allotted time during a presentation of the summary;
re-determining the compression metric for a portion of the source text based on the revised context-based allotted time when a remaining presentation time of the summary differs from the revised context-based allotted time; and
summarizing the portion of the source text as a function of a measure of the portion and the re-determined compression metric.

5. The method of claim 1, further including:
determining a revised context-based allotted time during a presentation of the summary; and
adjusting a presentation rate of the summary when a remaining presentation time of the summary differs from the revised context-based allotted time.

6. The method of claim 1, further including:
determining one or more of the context-based allotted time and a relevance of one or more portions of the source text from contextual information;
wherein the determining includes one or more of computing, looking-up, applying rules, inferring, and machine-based learning.

7. The method of claim 6, wherein the contextual information includes one or more of:
user-context information,
event information,
location information,
travel information,
environmental information, and
historical information.

8. A system, comprising:
a text summarization compression metric system to determine a compression metric as a function of a measure of a source text and a context-based allotted time in which to fit a summary of the source text, and to output the compression metric to a text summarization system to generate the summary as a function of the compression metric.

9. The system of claim 8, further including:
a contextual information evaluator to determine the context-based allotted time from user-context information;
wherein the user-context information includes one or more of schedule information, computer activity information, location information, motion information, and electronic messages.

10. The system of claim 8, further including:
a contextual information evaluator to apportion the context-based allotted time amongst multiple portions of the source text based on a relevance of the multiple portions of the source text;
wherein the text summarization compression metric system is configured to determine the compression metric for each of the portions of the source text as a function of the measure of the corresponding portion of the source text and the corresponding portion of the context-based allotted time.

11. The system of claim 8, wherein the compression metric system is configured to:
determine a revised context-based allotted time during a presentation of the summary; and
re-determine the compression metric for a portion of the source text based on the revised context-based allotted time when a remaining presentation time of the summary differs from the revised context-based allotted time.

12. The system of claim 8, wherein the compression metric system is configured to:
determine a revised context-based allotted time during a presentation of the summary; and
adjust a presentation rate of the summary when a remaining presentation time of the summary differs from the revised context-based allotted time.

13. The system of claim 8, further including:
a contextual information evaluator to determine one or more of the context-based allotted time and a relevance of one or more portions of the source text from contextual information;
wherein the contextual information evaluator includes one or more of a look-up table, computation system, a rule, an inference engine, and a learning system.

14. The system of claim 13, wherein the contextual information includes one or more of:
user-context information;
event information,
location information,
travel information,
environmental information, and
historical information.

15. A computer program product comprising a computer readable medium having computer program logic stored therein, wherein the computer program logic includes:
text summarization compression metric logic to cause a processor to determine a compression metric as a function of a measure of a source text and a context-based allotted time in which to fit a summary of the source text.

16. The computer program product of claim 15, further including:
contextual information evaluator logic to cause the processor to determine the context-based allotted time from user-context information;
wherein the user-context information includes one or more of schedule information, computer activity information, location information, motion information, and electronic messages.

17. The computer program product of claim 15, further including:
contextual information evaluator logic to cause the processor to apportion the context-based allotted time amongst multiple portions of the source text based on a relevance of the multiple portions of the source text;
wherein the text summarization compression metric logic includes logic to cause the processor to determine the compression metric for each of the portions of the source text as a function of the measure of the corresponding portion of the source text and the corresponding portion of the context-based allotted time.

18. The computer program product of claim 15, wherein the text summarization compression metric logic includes:
logic to cause the processor to determine a revised context-based allotted time during a presentation of the summary; and
logic to cause the processor to re-determine the compression metric for a portion of the source text based on the revised context-based allotted time when a remaining presentation time of the summary differs from the revised context-based allotted time.

19. The computer program product of claim 15, wherein the text summarization compression metric logic includes:
logic to cause the processor to determine a revised context-based allotted time during a presentation of the summary; and
logic to cause the processor to adjust a presentation rate of the summary when a remaining presentation time of the summary differs from the revised context-based allotted time.

20. The computer program product of claim 15, further including:
contextual information evaluator logic to cause the processor to determine one or more of the context-based allotted time and a relevance of one or more portions of the source text from contextual information;
wherein the contextual information evaluator logic includes one or more of a look-up table logic, computation logic, rules logic, inference logic, and learning logic.
